(19) United States
(12) Patent Application Publication
(10) Pub. No.: US 2019/0111360 A1
(43) Pub. Date: Apr. 18, 2019

(54) ENVIRONMENTALLY FRIENDLY DEMULSIFIERS

(71) Applicant: Baker Hughes, a GE company, LLC, Houston, TX (US)

(72) Inventors: Paul Hanna, Sugar Land, TX (US); Mindy Hai Nguyen, Houston, TX (US)

(73) Assignee: Baker Hughes, a GE company, LLC, Houston, TX (US)

(21) Appl. No.: 16/163,348

(22) Filed: Oct. 17, 2018

Related U.S. Application Data
(60) Provisional application No. 62/574,052, filed on Oct. 18, 2017.

(51) Int. Cl. B01D 17/04; C08G 63/08; C08G 63/85

(52) U.S. Cl. CPC B01D 17/047; C08G 63/85; C08G 63/08

(57) ABSTRACT

Environmentally friendly demulsifiers are useful to break emulsions, e.g. water-in-oil and oil-in-water emulsions, particularly oilfield emulsions, where the demulsifiers are polymers made by reacting a suitable resin with at least two different monomers, one having a Hansen solubility parameter similar to ethylene oxide and the other having a Hansen solubility parameter similar to propylene oxide, and where the polymers have an absence of ethylene oxide and/or propylene oxide. In a non-limiting embodiment, suitable resins include butyl resin, nonyl resin, nonyl/butyl resin, amyl resin, nonyl/butyl/amyl resin, phenol/formaldehyde resin, and combinations thereof. Suitable monomers include caprolactone, lactic acid, lactide, methacrylic acid ester, stearyl ester, hexyl ester, lauryl ester, urethane, ethylene adipate, vinyl esters, amides, allyl ethers, vinyl ethers, vinyl chloride, vinyl acetate, acrylic acid methyl ester, and combinations thereof.

### CROSS-REFERENCE TO RELATED APPLICATION

This application claims the benefit of U.S. Provisional Patent Application No. 62/574,052 filed Oct. 18, 2017, incorporated herein by reference in its entirety.

### TECHNICAL FIELD

The present invention relates to demulsifiers, and more particularly relates in one non-limiting embodiment to demulsifiers that are environmentally friendly polymers.

### TECHNICAL BACKGROUND

Demulsifiers, or emulsion breakers, are a class of specialty chemicals used to separate, resolve, or “break” emulsions (e.g. water-in-oil (w/o) emulsions or oil-in-water (o/w) emulsions) into an oil phase and a separate water phase. They are commonly used in the processing of crude oil, which is typically produced along with significant quantities of saline water. This water (and the salt) must be removed from the crude oil prior to refining. If the majority of the water and salt are not removed, significant corrosion problems can occur downstream in the refining process. Further, controlled emulsification, for instance in a desalter, and subsequent demulsification under controlled conditions are of significant value in removing impurities, particularly inorganic salts and other inorganic compounds, from crude oil. Emulsions formed by such controlled emulsification eventually must also be resolved or broken.

Oilfield produced water may contain residual quantities of oil and sometimes solid particles. The oil may be valuable to recover and the water may need to have the oil removed prior to discharge into the environment. Water clarifiers help remove these residual amounts of oil that may be usefully recovered and to obtain clarified water that may be subsequently used in a water flood project or steam flood program, or safely introduced into the environment. It is sometimes, but not always, possible that some polymers analogous to demulsifiers may be useful as water clarifiers.

Alkylene oxide polymers have long been known for their use in breaking emulsions. However, current demulsifiers are based on ethylene oxide (EO) and propylene oxide (PO) copolymers. These conventional demulsifiers are hazardous to produce and are not environmentally friendly.

It would thus be very desirable and important to discover methods and compositions for economically and rapidly resolving or “breaking” petroleum emulsions which are more environmentally friendly than current demulsifiers based on EO and PO copolymers.

### SUMMARY

There is provided, in one non-limiting embodiment, a method for making environmentally friendly demulsifiers comprising reacting at least two different monomers with a suitable resin, where at least one of the monomers is selected from the group including a monomer having a Hansen solubility parameter between 18-22 and is not ethylene oxide, and a monomer having a Hansen solubility parameter between 14-18 and is not propylene oxide, and combinations thereof.

There is also provided, in another non-restrictive version, an environmentally friendly demulsifier made by a process comprising reacting at least two different monomers with a resin, where at least one of the monomers is selected from the group including a monomer having a Hansen solubility parameter between 18-22 and is not ethylene oxide, a monomer having a Hansen solubility parameter between 14-18 and is not propylene oxide, and combinations thereof. These demulsifiers may also be used in methods to demulsify an emulsion comprising oil and water in an effective amount to at least partially demulsify the emulsion.

### BRIEF DESCRIPTION OF THE DRAWINGS

FIG. 1 is a graph of interfacial tension at an oil/water interface (mN/m) as a function of time (seconds) for a blank, three conventional demulsifiers, and seven experimental demulsifiers as described herein as Exp 1-7, and

FIG. 2 is a bar graph of downstream EDDA test results for a blank, three conventional demulsifiers, and seven experimental demulsifiers Exp 1-7 as a function of time.

### DETAILED DESCRIPTION

It has been discovered that by replacing the EO and PO groups in conventional demulsifiers with materials having similar Hansen solubility parameters, e.g., poly(lactic acid) and poly(caprolactone), respectively, that effective demulsifiers can be prepared that are readily biodegradable. It was realized that the critical factor in performance of the demulsifier relied on the solubility properties and compatibilities of these EO and PO chains. These solubility and compatibility properties could also be attained by substituting other monomers that have similar Hansen solubility parameters. In non-limiting embodiments, the environmentally friendly demulsifiers have an absence of both EO and PO, and alternatively the environmentally friendly demulsifier have either EO or PO, but not both, where the other monomer has been replaced. In these environmentally friendly demulsifiers two different monomers should be used, although it should be understood that additional, different monomers in addition to the two discussed are permitted herein unless they are explicitly excluded.

In one non-limiting embodiment, the term “environmentally friendly” as used herein means “readily biodegradable”. In another non-restrictive version “readily biodegradable” means the demulsifiers have an ability to degrade when subjected to sunlight, water, and/or microbial activity, to an extent ranging from 60 to 100 wt % in 56 days or less, alternatively in 42 days or less, and in another non-limiting embodiment in 28 days or less, or even alternatively in 10 days or less.

In other non-limiting versions, the EO monomer is replaced by a monomer having a Hansen solubility parameter between about 18 independently to about 22; alternatively between about 19 independently to about 21; whereas the PO monomer is replaced by a monomer having a Hansen solubility parameter between about 14 independently to about 18; alternatively between about 15 independently to about 17.

In an initial instance the solubility parameter of poly(ethylene oxide), 20 MPa^{1/2}, is essentially the same as that of poly(lactic acid) (PLA) (20 MPa^{1/2}) and the solubility parameter of poly(propylene oxide), 16 MPa^{1/2}, is essentially the same as that of poly(caprolactone) (PCL), 17 MPa^{1/2}. Thus, “essentially the same as” with respect to solubility parameters is defined herein as within ±1. These substitutions were made and the demulsifiers prepared. That is, demulsifiers were prepared using PCL first, then PLA. The lengths of the blocks were also varied. The order of addition was also reversed—PLA first, then PCL. Additionally the caprolactone and lactide were mixed together and added to the resin to prepare a random copolymer instead of the blocks of the other polymers. The environmentally friendly demulsifiers are not limited by the order of addition or whether they are block or random copolymers.

In more detail, current EO/PO demulsifiers have a general structure of formula (B):

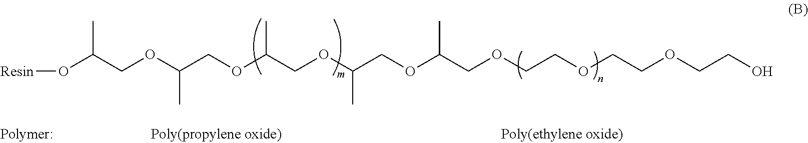

In one non-limiting embodiment, an environmentally friendly demulsifier as described herein has the structure of formula (A):

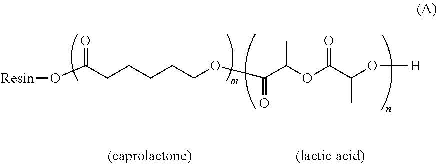

where at least m or n is at least 1, where the caprolactone moieties and the lactic acid moieties may occur in blocks, randomly, or a combination thereof, and where the resin is a moiety of butyl resin, nonyl resin, nonyl/butyl resin, amyl resin, nonyl/butyl/amyl resin, phenol/formaldehyde resin, and combinations thereof. In particular, the order of the blocks are not limited to that shown in formula (A), for instance, the lactic acid block may be first, followed by the caprolactone block. There is no actual upper limit for m and/or n, i.e. the block sizes, although practical limits may occur such as excessively high melting points or reduced solubility as the molecular weight gets too high and thus the polymers may be difficult to process or use.

In one non-limiting embodiment, the weight average molecular weight of the environmentally friendly demulsifiers may range from about 2000 independently to about 1,500,000 g/mol; alternatively from about 4000 independently to about 500,000 g/mol. The word “independently” as used herein with respect to ranges means that any lower threshold may be combined with any upper threshold to give an acceptable alternative range. In another non-restrictive version, in formula (A) above, m and n can each be zero so long as the other is not zero. Alternatively, independently from each other, one or both of m and n can range from 1 independently to 100; alternatively from about 1 independently to about 50; in another non-restrictive version from about 1 independently to 20; further from about 1 independently to about 10; also from 1 independently to about 5; and/or from 1 to 4 or 1 to 3.

In the case where caprolactone and/or lactic acid are used in the place of PO and EO, respectively, the following reactions are contemplated.

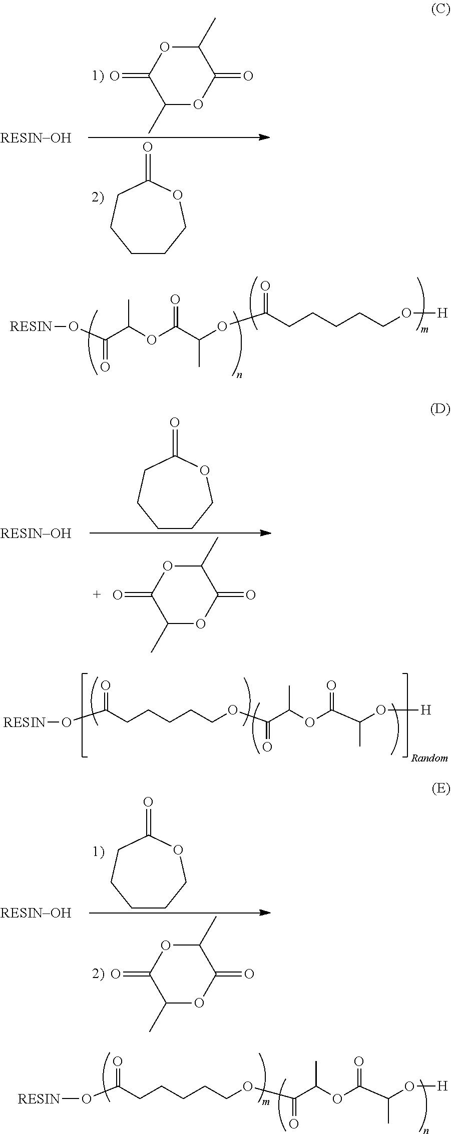

The subscripts m and n are as defined above. Reaction (C) involves reacting the resin first with lactide to give a poly(lactic acid) block and then reacting with caprolactone to give a poly(caprolactone) block. Reaction (D) involves reacting the resin with a mixture of lactide and caprolactone to give a random polymer. Reaction (E) involves reacting the resin first with caprolactone to give a poly(caprolactone) block and then reacting with lactide to give a poly(lactic acid) block. Also contemplated are above reactions where either ethylene oxide or propylene oxide are monomers, but not both.

Suitable resins include, but are not necessarily limited to, acid or base catalyzed butyl resin, acid or base catalyzed nonyl resin, acid or base catalyzed nonyl/butyl resin, acid or base catalyzed amyl resin, acid or base catalyzed nonyl/butyl/amyl resin, phenol/formaldehyde resin, and combinations thereof.

Suitable monomers having solubility parameters similar to PO (16 MPa^{1/2}) may include, but not necessarily be limited to, caprolactone, methacrylic acid ester, stearyl ester, hexyl ester, lauryl ester, and combinations thereof. Suitable monomers having solubility parameters similar to EO (20 MPa^{1/2}) may include, but not necessarily be limited to, lactic acid, lactide, urethane, ethylene adipate, vinyl esters, amides, allyl ethers, vinyl ethers, vinyl chloride, vinyl acetate, acrylic acid methyl ester, and combinations thereof.

The invention will now be illustrated with respect to certain Examples which are not intended to limit the invention, but instead to more fully describe it.

### Experiments 1-7

The process for making the environmentally friendly demulsifier polymers herein comprises or consists of adding the monomers in the order and amount desired along with an appropriate catalyst. In these specific examples the monomers (lactide and or caprolactone) were added in along with tin octoate catalyst. The mixture was heated to 90° C. overnight after each addition to ensure complete reaction of the monomer. There are other, known catalysts that would work for these monomers and different catalysts would be appropriate for different monomers.

Experiments 1, 3, 6, and 7 were conducted according to reaction (C). Experiment 5 was conducted according to reaction (D) to give a random copolymer. Experiments 2 and 4 were conducted according to reaction (E). The results are presented and summarized in Table I below. The resin used throughout was MZ 1580, which is an acid catalyzed resin available from Baker Hughes, a GE company. Commercial Demulsifier A and Commercial Demulsifier B (sometimes abbreviated as “CD A” and “CD B”, respectively) are conventional EO/PO demulsifiers.

TABLE I
Environmentally Friendly Demulsifiers of Experiments 1-7

| | % | % | % PLA | % PCL | Addition | |
|---|---|---|---|---|---|---|
| Samples | EO | PO | (like EO) | (like PO) | order | Appearance |
| Commercial | 26 | 45 | — | — | EO→PO | Liquid |
| Demulsifier | | | | | | |
| A | | | | | | |
| Commercial | 40 | 23 | — | — | EO→PO | Liquid |
| Demulsifier | | | | | | |
| B | | | | | | |
| Exp. 1 | — | — | 27 | 45 | PLA→PCL | Liquid |
| Exp. 2 | — | — | 27 | 45 | PCL→PLA | Low |
| | | | | | | solubility |
| Exp. 3 | — | — | 40 | 24 | PLA→PCL | Liquid |
| Exp. 4 | — | — | 40 | 24 | PCL→PLA | Low |
| | | | | | | solubility |
| Exp. 5 | — | — | 34 | 34 | PLA + PCL | Liquid |
| Exp. 6 | — | — | 31 | 53 | PLA→PCL | Liquid |
| Exp. 7 | — | — | 49 | 29 | PLA→PCL | Liquid, |
| | | | | | | two phases |

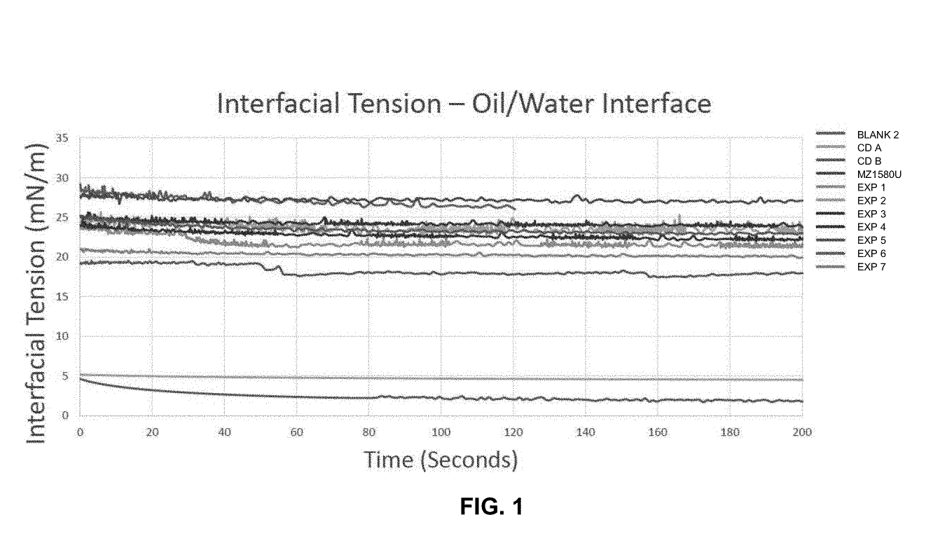

The new demulsifiers have been shown to migrate to the oil-water interface by the fact that they lower interfacial tension, as shown in FIG. 1. The blank crude oil has an interfacial tension with water at the value around 28 mN/m, while all of the new demulsifiers have interfacial surface tensions from about 19 to about 24 mN/m. MZ1580 is a starting material used for comparison.

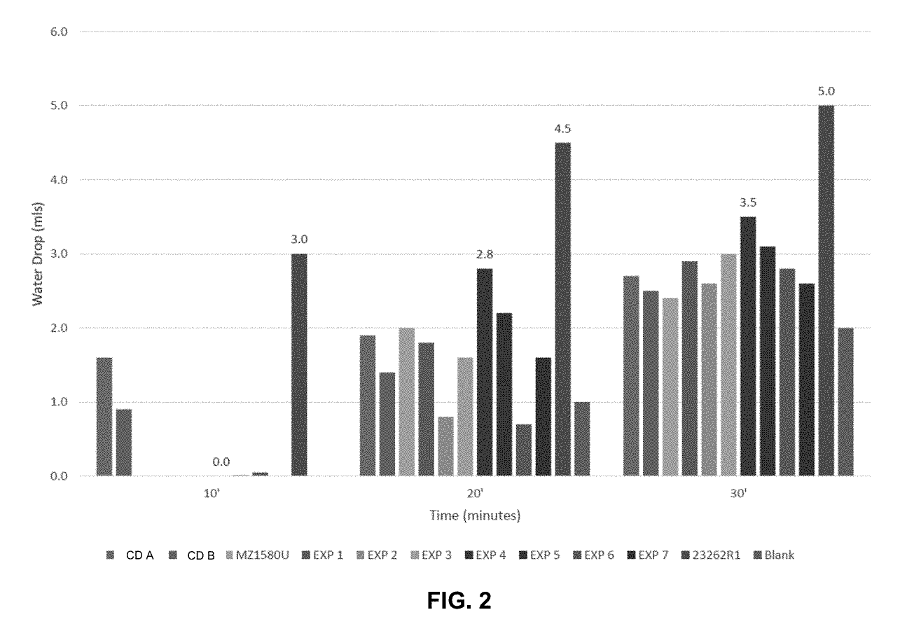

The demulsifiers were tested according to an Electrostatic Desalting Dehydration Apparatus (EDDA) Test Method similar to that used in U.S. Pat. No. 7,497,943 B2 (Baker Hughes, a GE corporation), incorporated herein by reference in its entirety. The EDDA is a laboratory test device to simulate a desalting process. The results are given in FIG. 2 which is a bar graph of water drop in milliliters (mls) as a function of time for a blank, three conventional demulsifiers, and seven experimental demulsifiers Exp 1-7.

It may thus be seen that the new demulsifiers help to separate the water from the oil. The data showed all the new demulsifiers performed similarly to or better than the current intermediate demulsifiers. The amount of water separated from the oil is more than the current commercial products. The new environmentally friendly demulsifiers are marked EXP 1 through EXP 7 in the Table II below. Table II shows the amount of water separated from the oil at 10 minutes, 20 minutes and 30 minutes. Higher values are better. The last two columns show how much total water was left in the oil phase at the end of the analyses. Lower values are better. It may be seen that EXP 6 performed significantly better than commercial products COMMERCIAL DEMULSIFER A, COMMERCIAL DEMULSIFER B, and starting resin, 23262R1, which is a Commercial Demulsifier. (T=Trace)

TABLE II
Demulsification Results

| Product | PPM | 10′ | 20′ | 30' | % W/% T | slug |
|---|---|---|---|---|---|---|
| CDA | 30 | 1.6 | 1.6 | 2.4 | 0/0.4 | 0.3 |
| CD B | 30 | 0.7 | 1.4 | 2.4 | 0/0.3 | 0.4 |
| 23262R1 | 30 | 0.0 | 1.0 | 2.0 | 0/0.8 | 0.8 |
| EXP 1 | 30 | 0.0 | 1.8 | 2.9 | 0/0.7 | 0.6 |
| EXP 2 | 30 | 0.0 | 0.8 | 2.6 | 0/0.8 | 0.7 |
| EXP 3 | 30 | 0.0 | 1.6 | 3.0 | 0/0.8 | 0.7 |
| EXP 4 | 30 | 0.0 | 2.8 | 3.5 | 0/0.8 | 0.7 |
| EXP 5 | 30 | 0.0 | 1.6 | 2.6 | 0/0.6 | 0.5 |
| EXP 6 | 30 | 0.1 | 0.7 | 2.8 | 0/T | 0.1 |
| EXP 7 | 30 | 0.0 | 1.6 | 2.6 | 0/0.4 | 0.4 |
| 23262R1 | 30 | 3.0 | 4.5 | 5.0 | 0.2/0.3 | 0.5 |
| Blank | 30 | 0.0 | 1.0 | 2.0 | 0/0.8 | 0.6 |

Effective demulsifying or water clarifying amounts or dosages of the polymer to break the emulsion ranges from about 5 ppm independently to about 1000 ppm; alternatively, from about 25 independently to about 500 ppm, on a weight/weight basis.

It should be appreciated that the emulsions that may be resolved or broken using the environmentally friendly demulsifier polymers described herein are not necessarily limited to those o/w and/or w/o emulsions found in the production and refining of hydrocarbons, but may generally be used in breaking emulsions comprising oil and water in other contexts including, but not necessarily limited to, cleaning processes, pharmaceutical processing, food science, paint technology, etc.

It is to be understood that the invention is not limited to the exact details of resins, monomers, reaction conditions, proportions, etc. shown and described, as modifications and equivalents will be apparent to one skilled in the art. The invention is therefore to be limited only by the scope of the appended claims. Further, the specification is to be regarded in an illustrative rather than a restrictive sense. For example, specific combinations of resins or other starting materials, monomers, reactant proportions, reaction conditions, molecular weights, dosages and the like falling within the described parameters herein, but not specifically identified or tried in a particular method or apparatus, are anticipated to be within the scope of this invention.

The present invention may suitably comprise, consist or consist essentially of the elements disclosed and may be practiced in the absence of an element not disclosed. For instance, there may be provided a method for making environmentally friendly demulsifiers comprising, consisting essentially of, or consisting of reacting at least two different monomers with a resin, where at least one of the monomers is selected from the group consisting of a monomer having a Hansen solubility parameter between about 18-22 and is not ethylene oxide, a monomer having a Hansen solubility parameter between about 14-18 and is not propylene oxide, and combinations thereof. The resin may be a moiety of butyl resin, nonyl resin, nonyl/butyl resin, amyl resin, nonyl/butyl/amyl resin, phenol/formaldehyde resin, and combinations thereof. These resins are considered suitable resins herein. There may also be provided environmentally friendly demulsifiers made by these methods.

Alternatively, there is provided an environmentally friendly demulsifier made by a process consisting essentially of or consisting of reacting a resin with at least two different monomer having Hansen solubility parameters of about 18 to about 22 in for a first monomer and from about 14 to about 18 for a second monomer.

Further, there may be provided a method of demulsifying an emulsion of oil and water comprising, consisting essentially of, or consisting of any of these environmentally friendly demulsifiers.

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

As used herein, the singular forms “a,” “an,” and “the” are intended to include the plural forms as well, unless the context clearly indicates otherwise.

As used herein, the term “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” in reference to a given parameter is inclusive of the stated value and has the meaning dictated by the context (e.g., it includes the degree of error associated with measurement of the given parameter).

What is claimed is:

1. A method for making demulsifiers comprising reacting at least two different monomers with a resin, where at least one of the two different monomers is selected from the group consisting of a monomer having a Hansen solubility parameter of from about 18 to about 22 that is not ethylene oxide, a monomer having a Hansen solubility parameter of from about 14 to about 18 that is not propylene oxide, and combinations thereof.

2. The method of claim 1 wherein the two different monomers are a monomer having a Hansen solubility parameter of from about 18 to about 22 which is not ethylene oxide and a monomer having a Hansen solubility parameter of from about 14 to about 18 which is not propylene oxide.

3. The method of claim 1 consists of reacting the resin with two different monomers with a resin, where one of the monomers is a monomer having a Hansen solubility parameter between from about 18 to about 22 and is not ethylene oxide and the other monomer has a Hansen solubility parameter of from about 14 to about 18 and is not propylene oxide.

4. The method of claim 1 where at least one of the monomers is selected from the group consisting of caprolactone, lactic acid, lactide, methacrylic acid ester, stearyl ester, hexyl ester, lauryl ester, urethane, ethylene adipate, vinyl esters, amides, allyl ethers, vinyl ethers, vinyl chloride, vinyl acetate, acrylic acid methyl ester, and combinations thereof.

5. The method of claim 1 where the monomer having a Hansen solubility parameter of from about 18 to about 22 that is not ethylene oxide is lactic acid or lactide and the monomer having a Hansen solubility parameter of from about 14 to about 18 that is not propylene oxide is caprolactone.

6. The method of claim 1 where the resin is selected from the group consisting of butyl resin, nonyl resin, nonyl/butyl resin, amyl resin, nonyl/butyl/amyl resin, phenol/formaldehyde resin, and combinations thereof.

7. The method of claim 1 where the number of moles of either of the at least two different monomers reacted with each mole of resin ranges from about 1 to about 100.

8. A demulsifier made by a process comprising reacting at least two different monomers with a resin, where at least one of the two different monomers is selected from the group consisting of a monomer having a Hansen solubility parameter of from about 18 to about 22 that is not ethylene oxide, a monomer having a Hansen solubility parameter of from about 14 to about 18 that is not propylene oxide, and combinations thereof.

9. The demulsifier of claim 8 where one of the at least two different monomers is a monomer having a Hansen solubility parameter of from about 18 to about 22 that is not ethylene oxide and the other one of the at least two different monomers is a monomer having a Hansen solubility parameter between from about 14 to about 18 that is not propylene oxide.

10. The demulsifier of claim 8 consisting of reacting the resin with two different monomers with a resin, where one of the monomers is a monomer having a Hansen solubility parameter between about 18 and about 22 and is not ethylene oxide and the other monomer has a Hansen solubility parameter between from about 14 to about 18 and is not propylene oxide.

11. The demulsifier of claim 8 where at least one of the at least two different monomers is selected from the group consisting of caprolactone, lactic acid, lactide, methacrylic acid ester, stearyl ester, hexyl ester, lauryl ester, urethane, ethylene adipate, vinyl esters, amides, allyl ethers, vinyl ethers, vinyl chloride, vinyl acetate, acrylic acid methyl ester, and combinations thereof.

12. The demulsifier of claim 8 where one or both of the at least two different monomers are selected from the group consisting of caprolactone, lactic acid, lactide, and combinations thereof.

13. The demulsifier of claim 8 where the resin is selected from the group consisting of butyl resin, nonyl resin, nonyl/butyl resin, amyl resin, nonyl/butyl/amyl resin, phenol/formaldehyde resin, and combinations thereof.

14. The demulsifier of claim 8 where the number of moles of either of the at least two different monomers reacted with each mole of resin ranges from about 1 to about 100.

15. A method of demulsifying an emulsion comprising oil and water comprising adding to the emulsion an effective amount of the demulsifier of claim 8 to at least partially demulsify the emulsion.

16. The method of claim 15 where the effective amount of the demulsifier ranges from about 5 to about 1000 ppm, on a weight/weight basis, based on the emulsion.

17. The method of claim 15 where at least one of the monomers is selected from the group consisting of caprolactone, lactic acid, lactide, methacrylic acid ester, stearyl ester, hexyl ester, lauryl ester, urethane, ethylene adipate, vinyl esters, amides, allyl ethers, vinyl ethers, vinyl chloride, vinyl acetate, acrylic acid methyl ester, and combinations thereof.

18. The method of claim 15 where one or both monomers are selected from the group consisting of caprolactone, lactic acid, lactide, and combinations thereof.

19. The method of claim 15 where the resin is selected from the group consisting of butyl resin, nonyl resin, nonyl/butyl resin, amyl resin, nonyl/butyl/amyl resin, phenol/formaldehyde resin, and combinations thereof.

20. The method of claim 15 where the number of moles of either monomer per mole of resin ranges from 1 to 100.
